(19) United States
(12) Patent Application Publication
(10) Pub. No.: US 2002/0046055 A1
(43) Pub. Date: Apr. 18, 2002

(54) Biometric verification system and method for internet services

(75) Inventors: Richard Martino, New York, NY (US); Moshe Tamir, New York, NY (US); Issac Levy, New York, NY (US); Wayne Weir, Overland Park, NY (US)

Correspondence Address: DARBY & DARBY P.C., 805 Third Avenue, New York, NY, 10022, US

(73) Assignee: Mediacom.net, LLC

(21) Appl. No.: 09/947,230

(22) Filed: Sep. 4, 2001

Related U.S. Application Data
(60) Provisional application No. 60/230,192, filed on Sep. 5, 2000.

(51) Int. Cl. G06F 17/60

(52) U.S. Cl. 705/1

(57) ABSTRACT

A method and system for implementing a call-back verification procedure for a commercial transaction which is presented to the consumer as part of the commercial transaction, i.e., at the website of the merchant, or alternatively, the consumer may be re-directed from the merchant's website to a different website where the call-back verification procedure is initiated. The consumer is required to input their call-back telephone number, along with payment information, such as, for example, a credit card number. The credit card information is then validated and the call-back number is checked to see if prior attempts have been made which were associated with the same call-back number. An automated voice response (AVR) unit is used for further interaction with the consumer and the consumer is asked to input a voice-print which will then be associated with the particular transaction the user is attempting to complete. An optional verification code may be provided to the user, which verification code is associated with the transaction being processed. The voice-print provided by the user is subsequently verified and stored in memory for subsequent use. At a later time, for example when the user calls customer service associated with the particular transaction to dispute the transaction, the voice-print may be retrieved from memory and played back to the user to confirm to the user that they had in fact previously authorized such transaction. The playback of the voice-print for confirmation purposes, may again be implemented from the merchant's website, or alternatively by directing the customer to the website of the verification system, or yet another alternative by which the customer is directed to call a specific telephone number to reach the verification system.

This application is based on and claims the priority under 35 U.S.C. § 119(e) of Provisional Application Ser. No. 60/230,192, filed Sep. 5, 2000, the contents of which are hereby incorporated herein by reference.

### FIELD OF THE INVENTION

The present invention generally relates to the field of communication and Internet systems. More specifically, the present invention relates to a system and method for using biometric information, such as voice-print information, for verifying Internet transactions and service requests.

### BACKGROUND OF THE INVENTION

With the increasing use of the Internet, more people are ordering goods and services over the Internet. In a typical transaction, a user goes to a website and selects particular goods or services which they wish to acquire. The goods and services are paid for using any of a number of different payment mechanisms and subsequently received by the consumer.

A problem often encountered in connection with Internet commerce is that of fraud. For example, goods or services may be ordered using fraudulent payment means, or goods and services may be ordered on behalf of a third party who has not in any way authorized such a transaction. Such situations usually lead to disputes between the merchant of the goods and services on the one hand, and the party which is to pay for the goods and services. Resolution of such disputes is often time consuming and expensive for both merchant and consumer alike.

To avoid such fraud scenarios, Internet merchants sometimes employ various anti-fraud schemes. One such anti-fraud scheme is to require a consumer to provide a call-back telephone number as part of the commercial transaction. After the commercial transaction is requested, and prior to shipping or providing the goods or services requested, the consumer is called back at the previously provided call-back number and asked to verify the transaction and provide a voice-print of the consumer's voice. The voice-print is then stored and associated with the particular commercial transaction. At a later time, if the consumer disputes the transaction, the previously stored voice-print is retrieved and played back to the consumer to confirm to the consumer that they had previously authorized the commercial transaction in dispute. If the previously stored voice-print does not match the voice of the consumer disputing the charge, then appropriate action may be taken by the consumer, such as canceling the charge, or investigating the matter in further detail.

The above-described call-back anti fraud mechanism has usually only been implemented in connection with telephone-based payment methods, i.e., commercial transactions in which the goods or serviced being ordered are being paid for by being charged to the consumer's telephone bill. One disadvantage of such a system is that it limits the available payment options for a consumer. If a consumer does not wish to pay for goods or services by way of their telephone bill, they are effectively precluded from purchasing such goods and services from a merchant that insists on implementing such call-back anti fraud mechanism in connection with telephone-based billing.

There is thus a need for a more universally acceptable payment system for Internet based commercial transactions which provides merchants with the security of a secure anti fraud system while at the same time providing consumers with the flexibility of a wider variety of payment options.

### SUMMARY OF THE INVENTION

According to the present invention, a method and system are provided for implementing a call-back verification procedure for a commercial transaction which allows consumers to use a wider variety of payment options, while at the same time affording merchants a sufficient level of security and anti-fraud protection. In one illustrative embodiment, the call-back verification procedure of the instant invention is provided to the consumer as part of the commercial transaction, i.e., at the website of the merchant, or alternatively, the consumer may be re-directed from the merchant's website to a different website where the call-back verification procedure is initiated. The process is very similar under either scenario.

As part of the verification procedure, the consumer is required to input their call-back telephone number, along with payment information, such as, for example, a credit card number. The credit card information is then validated and the call-back number is checked to see if prior attempts have been made which were associated with the same call-back number. This latter check is useful for determining fraud associated with those persons who repeatedly attempt to fraudulently complete commercial transactions, or alternatively, to place a limit on the number of transactions that a consumer may place over a given time period.

Subsequently, the process passes to an automated voice response (AVR) unit for further interaction with the consumer. As part of the AVR features implemented in conjunction with the present invention, the user is asked to input a voice-print which will then be associated with the particular transaction the user is attempting to complete. An optional verification code may be provided to the user, which verification code is associated with the transaction being processed.

The voice-print provided by the user is subsequently verified and stored in memory for subsequent use. At a later time, for example when the user calls customer service associated with the particular transaction to dispute the transaction, the voice-print may be retrieved from memory and played back to the user to confirm to the user that they had in fact previously authorized such transaction. The playback of the voice-print for confirmation purposes, may again be implemented from the merchant's website, or alternatively by directing the customer to the website of the verification system, or yet another alternative by which the customer is directed to call a specific telephone number to reach the verification system.

The verification system, especially, the playback portion of such system may be implemented as a computer-based and computer-accessible system, as long as the user has provisions for audio and/or video using their computer. Alternatively, it may be implemented completely as a telephone-based system. Further, while the summary description of the invention described above has been presented by way of an example utilizing voice-prints, the principles of the present invention are equally applicable to other biometric verification procedures involving other data, such as video, fingerprint, retina scan, and the like.

### BRIEF DESCRIPTION OF THE DRAWINGS

Other objects, features and advantages of the invention discussed in the above summary of the invention will be more clearly understood when taken together with the following detailed description of the preferred embodiments which will be understood as being illustrative only, and the accompanying drawings reflecting aspects of those embodiments, in which:

FIG. 1 is a block diagram of a system for implementing a call-back verification procedure for a commercial transaction according to the present invention;

FIG. 2 is a flowchart illustrating the initial user interaction for implementing a call-back verification procedure for a commercial transaction according to the present invention;

FIG. 3 is a flowchart illustrating additional processing for implementing the call-back verification procedure for a commercial transaction according to the present invention;

FIG. 4 is a flowchart illustrating the call-back portion and associated user interaction for the call-back verification procedure for a commercial transaction according to the present invention; and

FIG. 5 is a flowchart illustrating the subsequent verification portion of the call-back verification procedure for a commercial transaction according to the present invention.

### DETAILED DESCRIPTION OF THE PREFERRED EMBODIMENTS

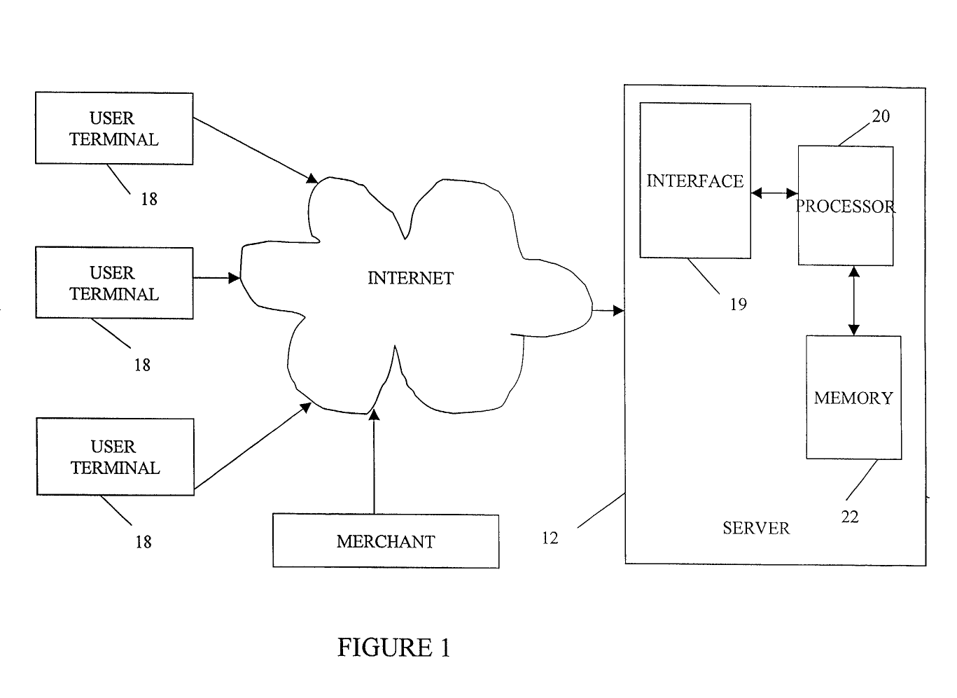

Referring now to the drawings, and particularly to FIG. 1, there is shown a block diagram of a system for implementing a call-back verification procedure for a commercial transaction according to the present invention. As shown in FIG. 1, the verification system 12 communicates with a communications network, such as the Internet 14, which in turn is in communication with a number of user terminals 18. One or more merchants 10 are also in communication with the Internet 14 so as to be able to interface with users 18 and the verification system 12. The verification system 12 may be implemented as a programmed computer typically including a server or other processing computer having an interface 19 for communicating with users, a processor 20 and memory 22.

The verification system 12 may be connected to a communication network facility 16 which provides for communication by way of telephone lines, data lines, or a functionally equivalent link to a number of users 18, each located at their respective terminal. The “terminals” referred to herein may be computers, telephones, interactive television, or any other suitable device which allows for bi-directional communication over a network in order to transmit the types of information which need to be transmitted in order to implement the verification procedure contemplated by the present invention. It will be apparent to those skilled in the art that communication network facility 16 may be a telephone or data network system, a cellular telephone system, or any other suitable communication system.

The verification system 12 includes the processor 20 coupled to the interface 19 in order to communicate with users 18, along with a memory 22 which stores the necessary program instructions for operating processor 20, as well as storing the data to be provided by the users 18, such as the voice-prints input by the users. The memory 22 may include cache memory, RAM memory, disk subsystem memory, optical media and/or tape and remote storage devices that can be accessed as needed.

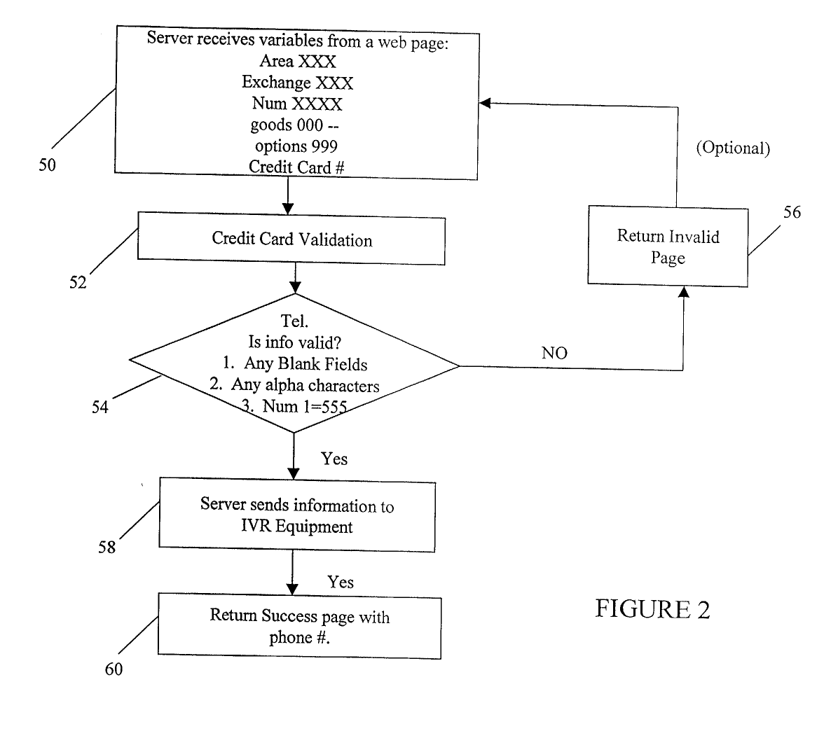

Referring now to FIG. 2, therein is illustrated a flowchart showing the initial user interaction for implementing a call-back verification procedure for a commercial transaction according to the present invention. The process begins at step 50 when the server receives the necessary information for a user. As discussed above, the process may be implemented as part of the merchant 10, or as a separate process which the consumer is directed to from the merchant 10. In either scenario, the processing is generally the same. The initially provided user information may include a telephone number, having an area code, exchange, and number, as is conventionally known. The user information may also include data identifying the particular goods or services for which the commercial transaction is being implemented (“goods 000”), as well as any options or other identifiers further specifying the goods or services (“options 999”). For example, the goods identifier may identify a magazine subscription, while the options identifier identifies the length and/or price of the subscription. The user input information also includes credit card information (“Credit Card #”).

The process continues to step 52 where the credit card information is validated, as is conventionally well known in the art. Next, the process proceeds to step 54 where the telephone information is validated. The checks performed at step 54 may include checks for blank fields input by the user, whether any alphabetic characters were input instead of numeric characters, and whether an invalid telephone number was input, for example, a telephone number having an exchange of “555”. If either the credit card information was not validated at step 52 or the telephone information was not validated at step 54, the process proceeds to step 56 where an “invalid” determination is transmitted back to the user. The user may then input different information. Optionally, the process may include a mechanism for limiting the number of opportunities the user may have to input the necessary information.

If the credit card information and telephone information is properly validated, the process continues to step 58 where the server passes the user input information to an IVR (interactive voice response) or AVR (automated voice response) system for further processing. If the IVR or AVR function is implemented as part of processor 20, then this step may not be needed, since this further processing is being performed within the server 12. The IVR or AVR equipment of functionality is well known in the art, and need not be discussed in further detail. Next, the process continues to step 60 where an indication is sent back to the consumer that they have successfully input the needed information and that they will be called back at the telephone number provided by the consumer.

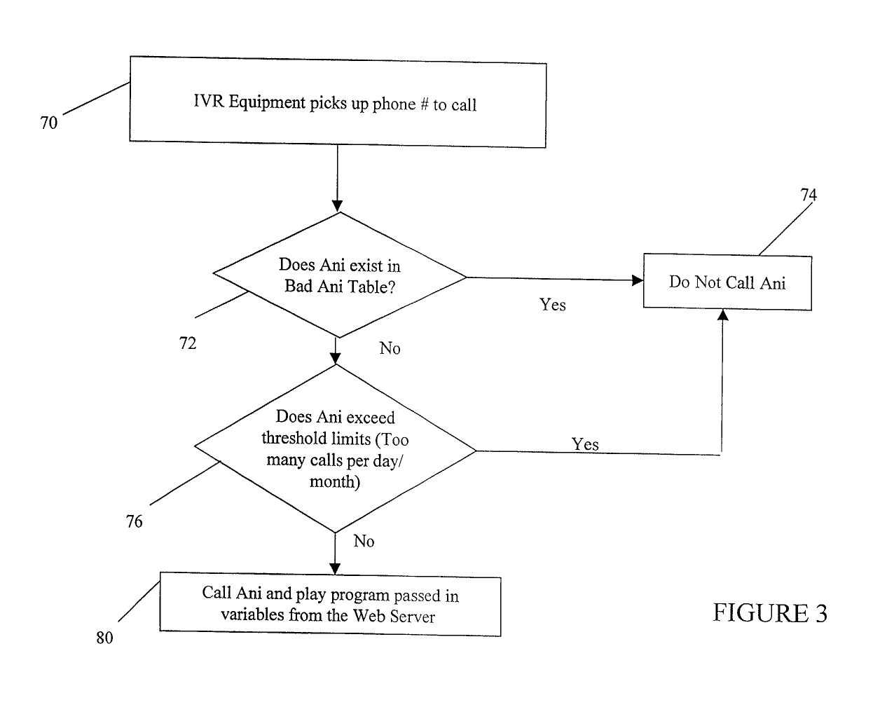

The next portion of the process is shown in FIG. 3. At step 70, the call-back telephone number is provided to the IVR equipment. The process then proceeds to step 72 where a check is made to see if the call-back telephone number is a “bad” telephone number, i.e., a telephone number which is somehow problematic. For example, the system may maintain a database of “bad” telephone numbers based on ANI (automatic number identification) information, indicating those numbers previously encountered and which presented problems. If the current call-back number is determined to be a “bad” number, the process proceeds to step 74, at which point the transaction is terminated, the call-back number is not called, and optionally, a message sent back to the user that the number provided is a “bad” number and no further processing will be performed.

If at step 72 the current call-back number passes the “bad” number check, the process continues to step 76 where a determination is made as to whether a predetermined number of requests have been received concerning the same call-back number. As part of this check, certain threshold limits may be set up, for example, a certain number of calls per day or per month. This type of check is an additional security precaution in that numerous requests for goods or services associated with the same telephone number oftentimes is an indication of fraudulent activity. If one of the thresholds is exceeded, the process continues to step 74 discussed above, and the particular transaction is terminated.

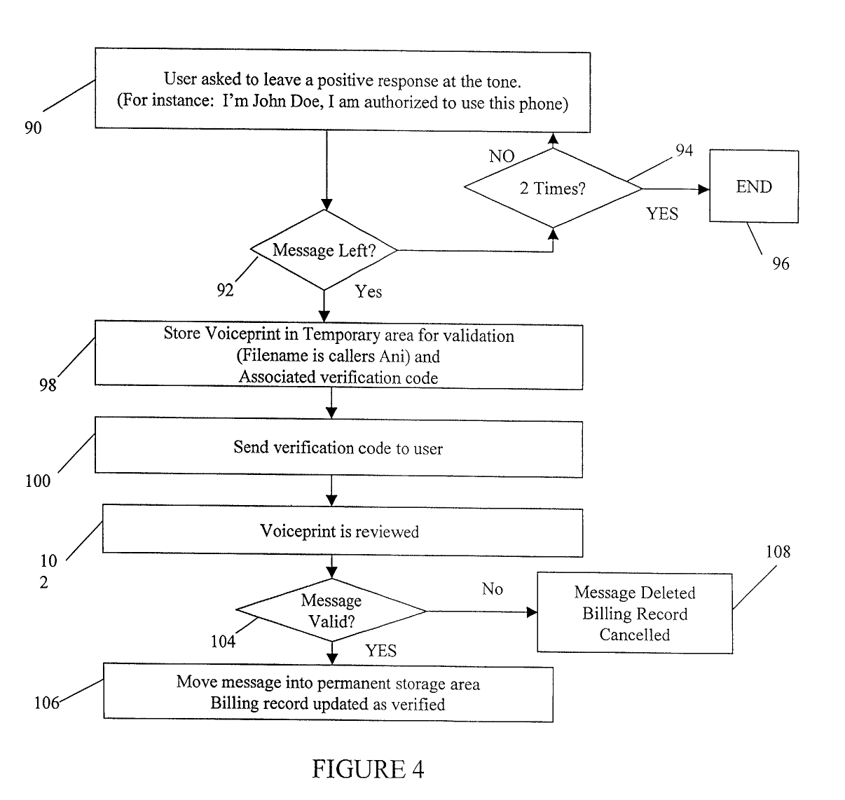

If at step 76 the threshold limit test is passed, the process proceeds to step 78 where the call-back number is contacted and a specific “script” or interaction with the user is implemented, depending on the particular transaction to be completed with the user. The process then continues to FIG. 4, where at step 90 where the user is asked to input a certain response, for example, “I am John Doe, I am authorized to use this phone.” The process continues to step 92 where a check is made to see if a response, for example an audio response, was in fact input by the user. If no response is detected at step 92, the process continues to step 94 where a count is made of the number of attempts provided to the user in order to input a response. If a predetermined threshold count is not exceeded, the process continues back to step 90 and the user is given another opportunity to input the desired response. If at step 94, the predetermined threshold count is found to have been exceeded, the process continues to step 96, and the transaction is terminated. Alternatively, if a message is detected at step 92, the process continues to step 98 where the voice-print is stored in a temporary memory for subsequent validation. The process then continues to step 100 where a validation code is transmitted to the user. This step 100 is optional and may be skipped in the process.

The process then continues to step 102 where the voice-print is reviewed (either by human or by machine voice recognition systems) to determine if the voice-print contains the expected message, i.e., did the user speak the required message as instructed during the earlier portion of the process. At step 104, it is determined whether the message is valid, and if so, the process continues to step 106 where the voice-print is stored in memory, i.e., a permanent storage area for subsequent use. However, if at step 104 it is determined that the voice-print is invalid, the process instead continues to step 108 where the voice-print is deleted from memory, along with the billing or transaction. Optionally, a message may be returned to the user indicating that the voice-print did not validate properly and that the transaction is being canceled. If the message is valid (steps 104 and 106), an indication may be provided to the merchant so that the merchant can continue and process the commercial transaction requested by the user.

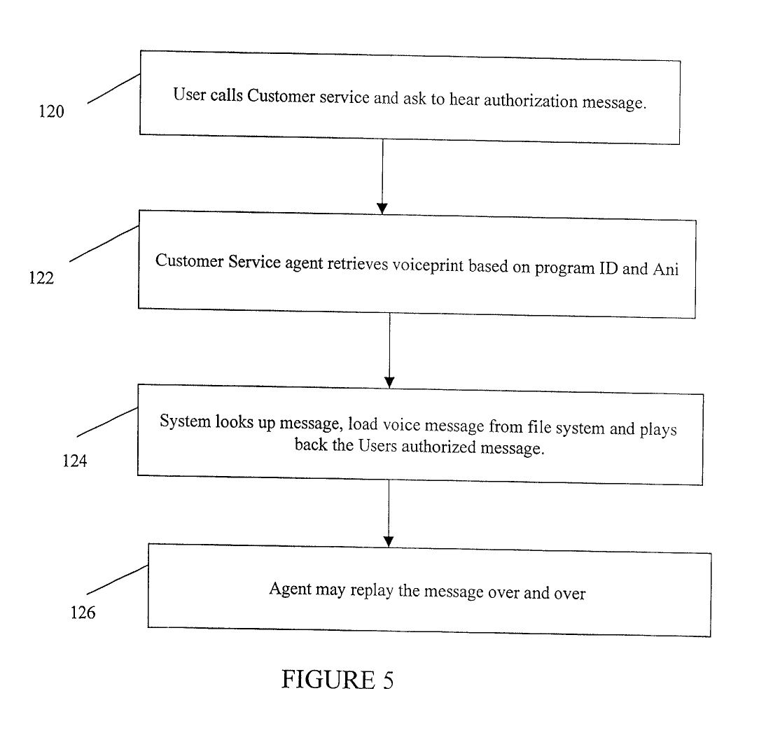

The use of a pre-stored voice-print is shown in connection with FIG. 5, and typically arises after a transaction, usually if a customer disputes the transaction for which they are being charged. Referring now to FIG. 5, this process typically begins when a customer calls the customer service function associated with the disputed commercial transaction or charge (step 120) and requests to hear the pre-stored voice-print. The customer service agent then retrieves the stored voice-print from memory based on the customer's telephone number (ANI) and the program ID or other identifying information indicating the particular subject of the commercial transaction (step 122). The process then proceeds to step 124 where the voiceprint is retrieved, and played back to the customer, and optionally played a number of times (step 126).

While the above description of a preferred embodiment has been presented by way of an example dealing with the use of voice-prints, the principles of the present invention are equally applicable to similar systems using other kinds of unique, identifying biometric indicia, such as visual images, fingerprints, retina scans and the like. In the case of visual images, a picture of the consumer is obtained in lieu of a voice-print. This may be accomplished using a camera mounted at each customer terminal 18. Similarly, a fingerprint may be obtained using a scanpad or other image input device connected to each customer terminal 18.

While forms of the invention have been described, it will be apparent to those skilled in the art that various modifications and improvements may be made without departing from the spirit and scope of the invention. As such, it is not intended that the invention be limited to the illustrative embodiments set forth herein.

What is claimed is:

1. A method for verifying a commercial transaction placed over a computer network by a purchaser using biometric information, said method comprising the steps of:
requesting over the computer network commercial transaction information from said purchaser;
requesting over the computer network biometric information from said purchaser that identifies said purchaser placing the commercial transaction;
receiving over the computer network said commercial transaction information and said biometric information from said purchaser;
recording said commercial transaction information and said biometric information; and
providing said biometric information to said purchaser to verify that said purchaser authorized said commercial transaction.

2. The method of claim 1, wherein said commercial transaction information includes credit card information.

3. The method of claim 1, wherein said biometric information includes at least one of fingerprint information, retinal information, and visual image information.

4. The method of claim 1, wherein said computer network is the Internet.

5. The method of claim 1, further including the step of requesting contact information from said purchaser, and wherein said contact information is used to contact said purchaser and request said biometric information from said purchaser.

6. The method of claim 5, wherein said contact information is telephone contact information.

7. The method of claim 5, further including the step of determining whether said contact information is valid contact information based on the input of prior contact information.

8. The method of claim 1, wherein said biometric information includes voice-print information.

9. The method of claim 8, further including the step of using at least one of an automated voice response (AVR) unit and an interactive voice response (IVR) unit to obtain the voice-print information.

10. The method of claim 6, further including the step of determining whether the telephone contact information has been provided a predetermined number of times in a given time period.

11. A computer readable medium encoded with processing instructions for performing a method for verifying a commercial transaction placed over a computer network by a purchaser using biometric information, said method comprising the steps of:
requesting over the computer network commercial transaction information from said purchaser;
requesting over the computer network biometric information from said purchaser that identifies said purchaser placing the commercial transaction;
receiving over the computer network said commercial transaction information and said biometric information from said purchaser;
recording said commercial transaction information and said biometric information; and
providing said biometric information to said purchaser to verify that said purchaser authorized said commercial transaction.

12. An apparatus for verifying a commercial transaction placed over a computer network by a purchaser using biometric information, comprising:
a processor;
an interface for communicating with said purchaser; and
a memory storing instructions for controlling said processor, said processor operative with the processing instructions to:
request over the computer network commercial transaction information from said purchaser;
request over the computer network biometric information from said purchaser that identifies said purchaser placing the commercial transaction;
receive over the computer network said commercial transaction information and said biometric information from said purchaser;
record said commercial transaction information and said biometric information; and
provide said biometric information to said purchaser to verify that said purchaser authorized said commercial transaction.

13. A method for providing biometric verification as part of a call-back security system, utilizing a voice-print input by a user, the method comprising the following steps:
instructing the user to input a call-back telephone number and credit card number associated with a particular commercial transaction;
validating the credit card number input by the user;
validating the call-back telephone number input by the user;
instructing the user to provide a voice-print associated with the user;
storing the input voice-print in memory; and
playing back the stored voice-print to the user.
